(19) United States
(12) Patent Application Publication
(10) Pub. No.: US 2026/0046182 A1
(43) Pub. Date: Feb. 12, 2026

(54) METHOD OF ADAPTIVE TRANSMISSION BEAM SWEEPING, METHOD OF CONTROLLING ADAPTIVE TRANSMISSION BEAM SWEEPING, USER EQUIPMENT, BASE STATION AND COMPUTER READABLE MEDIA

(71) Applicant: HUAWEI TECHNOLOGIES CO., LTD., Shenzhen (CN)

(72) Inventors: Zhibin Yu, Munich (DE); Xiaofeng Wu, Munich (DE); Ahmed Abdelkader, Munich (DE)

(73) Assignee: HUAWEI TECHNOLOGIES CO., LTD., Shenzhen (CN)

(21) Appl. No.: 19/360,160

(22) Filed: Oct. 16, 2025

Related U.S. Application Data
(63) Continuation of application No. PCT/EP2023/059862, filed on Apr. 17, 2023.

(51) Int. Cl. H04L 27/26; H04B 7/06; H04W 52/36

(52) U.S. Cl. CPC H04L 27/261; H04B 7/06952; H04W 52/365

(57) ABSTRACT

To achieve adaptive transmission beam sweeping, a user equipment sweeps one or more transmit, TX, beams to transmit a Sounding Reference Signal, SRS, sequence within one SRS orthogonal frequency-division multiplexing, OFDM, signal duration, wherein each TX beam is applied on a group of time consecutive waveform repetitions within the SRS OFDM signal duration.

### CROSS-REFERENCE TO RELATED APPLICATIONS

This application is a continuation of International Application No. PCT/EP2023/059862, filed on Apr. 17, 2023, the disclosure of which is hereby incorporated by reference in its entirety.

### TECHNICAL FIELD

The disclosure relates generally to uplink beam management in next generation wireless communication systems, and more particularly, the disclosure relates to methods of adaptive transmission beam sweeping, controlling adaptive beam sweeping in 5^{th} generation, 5G communication systems including user equipment, base stations and related computer readable media.

### BACKGROUND

MmWave Band Communications have been adopted by 5^{th} Generation New Radio, 5G NR cellular technologies, which significantly improve the data throughput for cellular communications. For the mmWave band communications, compared with legacy sub-6 Ghz band communication, a gain of an individual Radio Frequency, RF antenna is much smaller. To overcome the gain of the individual RF, and to maintain the low power consumption, analogue beamforming is commonly provided for the mmWave Band RF front-end realization in a User Equipment, UE device. The UE transmitter based on analogue beamforming employs an antenna array to control the radiation direction of the beamformed transmitted signal controlled through analogue phase shifters associated with the antenna array. However, due to the nature of the analogue beamforming, transmission, TX beam switching is limited to a time domain multiplexing, TDM after the digital-to-analogue converter, DAC. To achieve efficient analogue beamforming, the UE needs to perform UE TX beam selection, which enables the UE identify a best phase shifter setting i.e., best UE TX beam, which steers the TX signal to an optimal direction of a Base station, BS receiver, where this process may be crucial not only during the initial connection phase, but also when the UE is moving, and recursive activation of the UE TX beam selection is necessary for the mmWave band communication.

Existing solution addresses the problem of the UE TX beam selection by copying the acquired best UE RX phase shifter i.e. the best UE RX beam, setting and uses it as the best UE TX phase shifter setting i.e. the best UE TX beam, where the best UE RX beam can be obtained from Downlink, DL beam management procedures. However, this approach may not provide accurate beam measurements due to asymmetric circuitry design of TX RF frontends (e.g. Power Amplifier, PA), RX RF frontends (e.g. Low Noise Amplifier, LNA), and non-reciprocity of wireless propagation channels. Additionally, latency issues may arise as the best UE TX beam can only be identified after the best UE RX beam has been identified, which can cause problems in Uplink, UL latency sensitivity communication scenarios, such as remote driving or remote sensing.

Another existing solution is to apply Sounding Reference Signal, SRS based UE TX beam sweeping, which involves the UE transmitting a burst of SRS Orthogonal Frequency Division Multiplexing, OFDM signals with each SRS OFDM signal transmitted using one candidate UE TX beam. The base station measures the received powers of the SRS OFDM signals and indicates back to the UE which SRS OFDM signal index corresponds to the best UE TX beam. For example, the BS can prompt the UE to transmit 8 SRS OFDM signals within two UL slots, with each SRS OFDM signal transmitted using a distinct UE candidate TX beam. The BS subsequently evaluates received reference signal quality i.e. Reference Signal Received Power, RSRP, of the SRS OFDM signals, and informs the UE on which is the best performing SRS OFDM signal index with the best RSRP.

A major drawback of using the existing solution is that the number of SRS OFDM signals required for UE TX beam sweeping increases as the number of candidate UE TX beams increases. For example, a UE with a 2×2 antenna array using DFT beams with a typical spatial over sampling factor of 4, has a total of 16 candidates TX beams. If each UL slot can transmit up to 4 SRS OFDM signals (The other OFDM signals are used to transmit the Physical Uplink Shared Channel, PUSCH signals for UL data communication), which requires 4 UL slots to complete the SRS based UE TX beam sweeping. If a typical time interval between two UL slots with the SRS is 20 ms, then the SRS based UE TX beam sweeping will be completed with a latency of 80 ms, resulting in generating high latency and high training overhead for the mmWave band communications, especially in scenarios where the UE is already heavily loaded with UL data traffic such as the remote sensing scenario.

Therefore, there arises a need to address the aforementioned drawbacks of prior arts and provide a solution for efficient UE TX beam selection. There is a need to provide a solution that addresses latency issues faced by prior art approaches during SRS based UE TX beam sweeping whilst maintaining the accuracy of UE TX beam measurement and detection at the BS side.

### SUMMARY

It is an object of the disclosure to provide a method of adaptive transmission beam sweeping, a method of controlling adaptive transmission beam sweeping, a User Equipment, UE, and a Base Station, BS, while avoiding one or more disadvantages of prior art approaches.

This object is achieved by the features of the independent claims. Further, implementation forms are apparent from the dependent claims, the description, and the figures.

The disclosure provides a method of adaptive transmission beam sweeping, a method of controlling adaptive transmission beam sweeping, a User Equipment, UE and a Base Station, BS configured therefor.

According to a first aspect, there is provided a method of adaptive transmission beam sweeping. The method includes a user equipment, UE, sweeping one or more transmit, TX, beams to transmit a Sounding Reference Signal, SRS, sequence within one SRS orthogonal frequency-division multiplexing, OFDM, signal duration. Each TX beam is applied on a group of time consecutive waveform repetitions within the SRS OFDM signal duration.

This method facilitates a substantial reduction in the latency during SRS based UE TX beam sweeping while maintaining accurate UE TX beam measurement and detection on the BS side. This method being dynamic in nature, facilitates optimization of beam measurement accuracy for various communication scenarios. This method requires low training overhead for mmWave band communications, and efficiently identifies the best UE TX beam with reduced SRS based UE TX beam sweeping latency.

In an embodiment, the method further includes receiving an SRS trigger message from a base station, BS by the UE. The SRS trigger message triggers the transmitting of the SRS sequence within the SRS OFDM signal duration and includes a split factor setting a number of the TX beams to be swept within the SRS OFDM signal duration. The split factor is an integer with a range from one to a frequency domain down-sampling factor of the SRS OFDM signal. The method further includes determining a TX beam switching pattern by the UE for transmitting the SRS sequence within the SRS OFDM signal duration based on the split factor and the frequency domain down-sampling factor of the SRS OFDM signal. The method further includes determining a transmission power allocated to each TX beam to be swept within the SRS OFDM signal duration in accordance with the split factor by the UE.

According to a second aspect, there is provided a method of controlling adaptive transmission beam sweeping. The method includes a base station, BS, scheduling one or more User Equipment, UEs to transmit a Sounding Reference Signal, SRS, sequence with sweeping by each of the UEs one or more transmit, TX, beams within one SRS orthogonal frequency-division multiplexing, OFDM, signal duration. Each TX beam is to be applied on a group of time consecutive waveform repetitions within the SRS OFDM signal duration.

This method enables the BS to efficiently identify the best UE TX beam with reduced latency following the SRS based UE TX beam sweeping. This method enables the BS to dynamically select and configure the number of swept UE TX beams within one SRS OFDM signal duration, based on the propagation conditions of the wireless channel, so that the minimal required received power per UE TX beam can be guaranteed to allow sufficient beam measurement accuracy in the BS side. This method is dynamic and is recursively activated to perform accurate beam measurements by the BS even when the UE is moving.

In an embodiment, the method further includes the BS sending an SRS trigger message to each of the scheduled UEs to trigger the transmitting of the SRS sequences within the SRS OFDM signal duration. Each SRS trigger message comprises a split factor setting a number of the TX beams to be swept within the SRS OFDM signal duration. The split factor being an integer with a range from one to a frequency domain down-sampling factor of the SRS OFDM signal. The value of the split factor corresponds to the number of district UE TX beams to be swept within one SRS OFDM signal.

In an embodiment, the method further includes the BS defining the split factor based on a beam switching capability of a UE, and a run-time observation of a service type of the UE and wireless channel conditions, including a path-loss between the BS and the UE.

In an embodiment, the path-loss between the BS and the UE is determined by the BS based on a power difference between a BS transmission power and a UE received power of a downlink reference signal. The UE received power is provided to the BS in a historical measurement report message from the UE.

In an embodiment, the path-loss between the BS and the UE is determined by the BS based on a power difference between a UE transmission power and a BS received power of a historical Physical Uplink Shared Channel, PUSCH, signal. The UE transmission power of the PUSCH signal is determined by the BS based on a power-head room, PHR, report embedded within a PUSCH traffic data.

In an embodiment, the path-loss between the BS and the UE is determined by the BS based on a relative position information between the BS and the UE obtained by historical round-trip-time, RTT, measurements.

In an embodiment, the method further includes the BS refining the split factor based on wireless channel parameters measured from historically received uplink signals, including one or more of a signal-to-interference-ratio, SINR, a delay spread, and mobility metrics of the UE.

In an embodiment, the beam switching capability of the UE includes a latency of the UE TX beam switching. The latency including a beam switching transition period between a first beam pattern and a second beam pattern in the UE within one SRS OFDM signal duration.

In an embodiment, if the BS schedules one UE to transmit the SRS sequence within the SRS OFDM signal duration, the method including the BS independently measuring an SRS sequence receive power for each group of waveform repetitions received within the SRS OFDM signal duration, and the BS identifying a preferred TX beam for the scheduled UE by comparing the SRS sequence receive powers measured for different groups of waveform repetitions within the SRS OFDM signal duration.

In an embodiment, if the BS schedules multiple UEs to transmit the SRS sequences within the SRS OFDM signal duration, the method further including the BS measuring an SRS sequence receive power corresponding to each of the scheduled UEs for each group of waveform repetitions received within the SRS OFDM signal duration with separating the SRS sequences from different UEs in the same group of waveform repetitions based on Code Division Multiplexing, CDM, orthogonality of the SRS sequences, and the BS identifying a preferred TX beam for each of the scheduled UEs by comparing the measured SRS sequence receive powers corresponding to said UE for different groups of waveform repetitions within the SRS OFDM signal duration.

In an embodiment, the method further including the BS sending an indication message to each of the scheduled UEs comprising a first index identifying an SRS OFDM signal and a second index identifying a group of waveform repetitions within the SRS OFDM signal duration on which the preferred TX beam for said UE has been measured.

According to a third aspect, there is provided a user equipment, UE, being configured for sweeping one or more transmit, TX, beams to transmit a Sounding Reference Signal, SRS, sequence within one SRS orthogonal frequency-division multiplexing, OFDM, signal duration. Each TX beam is applied on a group of time consecutive waveform repetitions within the SRS OFDM signal duration.

The UE is adapted to determine a TX beam switching pattern and apply the TX beam switching pattern onto a group of consecutive waveform repetitions of a single SRS OFDM signal. The UE is adapted to perform SRS based TX beam sweeping to facilitate identification of the best UE TX beam for future use in efficient UL data transmission. The UE enables finding better transmission path and updating setting for actual UL data transmission.

In an embodiment, the user equipment, UE, being configured for receiving an SRS trigger message from a base station, BS. The SRS trigger message triggers the transmitting of the SRS sequence within the SRS OFDM signal duration and includes a split factor setting a number of the TX beams to be swept within the SRS OFDM signal duration. The split factor is an integer with a range from one to a frequency domain down-sampling factor of the SRS OFDM signal. In an embodiment, the UE being configured for determining a TX beam switching pattern for transmitting the SRS sequence within the SRS OFDM signal duration based on the split factor and the frequency domain down-sampling factor of the SRS OFDM signal. In an embodiment, the UE being configured for determining a transmission power allocated to each TX beam to be swept within the SRS OFDM signal duration in accordance with the split factor.

According to a fourth aspect, there is provided a base station, BS, being configured for scheduling one or more UEs to transmit a Sounding Reference Signal, SRS, sequence with sweeping by each of the UEs one or more transmit, TX, beams within one SRS orthogonal frequency-division multiplexing, OFDM, signal duration. Each TX beam is applied on a group of time consecutive waveform repetitions within the SRS OFDM signal duration.

The BS establishes mmWave band communications link with the UE to enable efficient TX beam sweeping. The BS interacts with the UE and determines a split factor based on inputs received, which is presented to the UE for performing TX beam sweeping. The BS controls the UE TX beam sweeping process and facilitates identification of the best TX beam to be presented to the UE for use in further UL data transmission. The BS facilitates the UE to perform analogue beamforming more efficiently thereby allowing targeted data transfer with high accuracy.

In an embodiment, the base station, BS, being configured for sending an SRS trigger message to each of the scheduled UEs to trigger the transmitting of the SRS sequences within the SRS OFDM signal duration. Each SRS trigger message comprises a split factor setting a number of the TX beams to be swept within the SRS OFDM signal duration. The split factor being an integer with a range from one to a frequency domain down-sampling factor of the SRS OFDM signal.

In an embodiment, the base station, BS, being configured for determining the split factor based on a beam switching capability of a UE, and a run-time observation of a service type of the UE and wireless channel conditions, including a path-loss between the BS and the UE.

In an embodiment, the base station, BS, being configured for determining the path-loss between the BS and the UE based on a power difference between a BS transmission power and a UE received power of a downlink reference signal. In an embodiment, the UE received power is provided to the BS in a historical measurement report message from the UE.

In an embodiment, the base station, BS, being configured for determining the path-loss between the BS and the UE based on a power difference between a UE transmission power and a BS received power of a historical Physical Uplink Shared Channel, PUSCH, signal. In an embodiment, the UE transmission power of the PUSCH signal is determined by the BS based on a power-head room, PHR, report embedded within a PUSCH traffic data.

In an embodiment, the base station, BS, being configured for determining the path-loss between the BS and the UE based on a relative position information between the BS and the UE obtained by historical round-trip-time, RTT, measurements.

In an embodiment, the base station, BS, being configured for refining the split factor based on wireless channel parameters measured from historically received uplink signals, including one or more of a signal-to-interference-ratio, SINR, a delay spread, and mobility metrics of the UE.

In an embodiment, the base station, BS, being configured for determining the beam switching capability of the UE by determining a latency of the UE TX beam switching. In an embodiment, the latency including a beam switching transition period between a first beam pattern and a second beam pattern in the UE within one SRS OFDM signal duration.

In an embodiment, in case one UE is scheduled to transmit the SRS sequence within the SRS OFDM signal duration, the base station, BS, being configured for independently measuring an SRS sequence receive power for each group of waveform repetitions received within the SRS OFDM signal duration, and identifying a preferred TX beam for the scheduled UE by comparing the SRS sequence receive powers measured for different groups of waveform repetitions within the SRS OFDM signal duration.

In an embodiment, in case multiple UEs are scheduled to transmit the SRS sequences within the SRS OFDM signal duration, the base station, BS, being configured for measuring an SRS sequence receives power corresponding to each of the scheduled UEs for each group of waveform repetitions received within the SRS OFDM signal duration with separating the SRS sequences from different UEs in the same group of waveform repetitions based on Code Division Multiplexing, CDM, orthogonality of the SRS sequences, and identifying a preferred TX beam for each of the scheduled UEs by comparing the measured SRS sequence receive powers corresponding to said UE for different groups of waveform repetitions within the SRS OFDM signal duration.

In an embodiment, the base station, BS, being further configured for sending an indication message to each of the scheduled UEs comprising a first index identifying an SRS OFDM signal and a second index identifying a group of waveform repetitions within the SRS OFDM signal duration on which the preferred TX beam for said UE has been measured.

According to a fifth aspect, there is provided a non-transitory computer readable medium having instructions stored thereon which, when executed by a processor, cause the processor to implement a method of adaptive transmission beam sweeping.

According to a sixth aspect, there is provided a non-transitory computer readable medium having instructions stored thereon which, when executed by a processor, cause the processor to implement a method of controlling adaptive transmission beam sweeping.

Therefore, in contradistinction to the existing solutions of prior art, the method of adaptive transmission beam sweeping of the present disclosure significantly reduces the latency involved in SRS based UE TX beam sweeping whilst ensuring high accuracy for UE TX beam measurement and detection. This method is dynamic, and recursively activated to consider the movement of the UE, and thus facilitates efficient beam management with minimal latency issues. This method reduces the beam training latency for UE TX beam sweeping whilst optimizing the beam measurement accuracy for different communication scenarios in 5G NR mmWave band communications.

These and other aspects of the disclosure will be apparent from the implementation(s) described below.

### BRIEF DESCRIPTION OF DRAWINGS

Implementations of the disclosure will now be described, by way of example only, with reference to the accompanying drawings, in which:

FIG. 1 is a block diagram of a User Equipment, UE, in accordance with an implementation of the disclosure;

FIG. 2 is a block diagram of a Base Station, BS, in accordance with an implementation of the disclosure;

FIG. 3 is an exemplary graphical representation of different Sound Reference Signal, SRS, comb modes, and their waveform repetitions for one SRS Orthogonal Frequency Division Multiplexing, OFDM, signal in accordance with an implementation of the disclosure;

FIGS. 4A-4C are illustrations of a Base Station, BS, with three modes for performing User Equipment, UE, Transmit, TX, beam sweeping by the UE in accordance with implementations of the disclosure;

FIG. 5 shows an exemplary graphical representation of frequency domain sub-carrier pattern of comb-4 SRS structure in accordance with an implementation of the disclosure;

FIG. 6 shows an exemplary graphical representation of transmitted SRS waveform in a UE transmitter side in accordance with an implementation of the disclosure;

FIG. 7 is a graphical illustration of received SRS waveform in a BS receiver side with single UE in accordance with an implementation of the disclosure;

FIG. 8 is an exemplary graphical illustration of received SRS waveform in the BS receiver side with multiple UEs in accordance with an implementation of the disclosure;

FIG. 9 is a graphical illustration of TX beam sweeping pattern for a UE with long beam switching transition period in accordance with an implementation of the disclosure;

FIG. 10 is a graphical illustration of TX beam sweeping pattern for a UE with short beam switching transition period in accordance with an implementation of the disclosure;

FIG. 11 is an exemplary graphical illustration of BS sent message to a UE indicating a best TX beam in accordance with an implementation of the disclosure;

FIG. 12 is an interaction diagram illustrating a procedure of adaptive SRS TX beam sweeping in accordance with an implementation of the disclosure;

FIG. 13 illustrates a flow diagram of a method of adaptive transmission beam sweeping in accordance with an implementation of the disclosure;

FIG. 14 illustrates a flow diagram of a method of controlling adaptive transmission beam sweeping in accordance with an implementation of the disclosure; and

FIG. 15 is an illustration of a computer system (e.g., a user equipment) in which the various architectures and functionalities of the various previous implementations may be implemented.

### DETAILED DESCRIPTION OF THE DRAWINGS

Implementations of the disclosure provide a method of adaptive transmission beam sweeping, a method of controlling adaptive transmission beam sweeping, a User Equipment, UE, a Base Station, BS, and computer readable media configured therefor.

To make solutions of the disclosure more comprehensible for a person skilled in the art, the following implementations of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

### Definitions

Waveform Repetition, WP, refers to a repeated waveform in the time domain (due to frequency domain down sampling) within one SRS OFDM signal duration.

Waveform Repetition Group, WPG, refers to a number of time consecutive WPs within one SRS OFDM signal duration.

Split Factor is defined to be the number of waveform repetition groups, WPGs, within one SRS OFDM signal duration. Each of the WPG is a group of time consecutive WPs within the SRS OFDM signal duration.

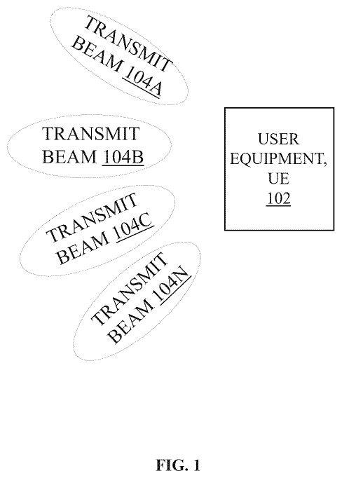

FIG. 1 is a block diagram of a UE 102, in accordance with an implementation of the disclosure. The UE 102 is configured for sweeping one or more transmit, TX, beams 104A-N to transmit a Sounding Reference Signal, SRS, sequence within one SRS orthogonal frequency-division multiplexing, OFDM, signal duration. Each TX beam is applied on a group of time consecutive waveform repetitions within the SRS OFDM signal duration.

The UE 102 is adapted to determine a TX beam switching pattern and apply the TX beam switching pattern onto a group of consecutive waveform repetitions of a single SRS OFDM signal. The UE 102 is adapted to perform SRS based TX beam sweeping to facilitate identification of the best UE TX beam for future use in efficient UL data transmission. The UE 102 enables finding better transmission path and updating setting for actual UL data transmission.

In an embodiment, the UE 102, being configured for receiving an SRS trigger message from a base station, BS. The SRS trigger message triggers the transmitting of the SRS sequence within the SRS OFDM signal duration and includes a split factor setting a number of the TX beams to be swept within the SRS OFDM signal duration. The split factor is an integer with a range from one to a frequency domain down-sampling factor of the SRS OFDM signal. In an embodiment, the UE 102 being configured for determining a TX beam switching pattern for transmitting the SRS sequence within the SRS OFDM signal duration based on the split factor and the frequency domain down-sampling factor of the SRS OFDM signal. In an embodiment, the UE 102 being configured for determining a transmission power allocated to each TX beam to be swept within the SRS OFDM signal duration in accordance with the split factor.

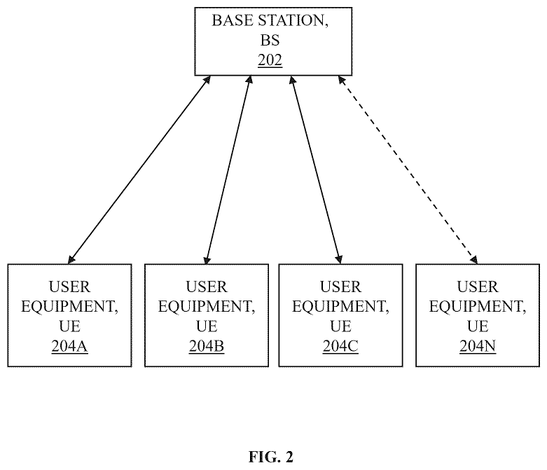

FIG. 2 is a block diagram of a BS 202, in accordance with an implementation of the disclosure. The BS 202 is configured for scheduling one or more UEs 204A-N to transmit a Sounding Reference Signal, SRS, sequence with sweeping by each of the UEs 204A-N one or more transmit, TX, beams within one SRS orthogonal frequency-division multiplexing, OFDM, signal duration. Each TX beam is applied on a group of time consecutive waveform repetitions within the SRS OFDM signal duration.

The BS 202 establishes mmWave band communications link with the UE 204A-N to enable efficient TX beam sweeping. The BS 202 interacts with the UE 204A-N and determines a split factor based on inputs received, which is presented to the UE 204A-N for performing TX beam sweeping. The BS 202 controls the UE TX beam sweeping process, and facilitates identification of the best TX beam to be presented to the UE 204A-N for use in further UL data transmission. The BS 202 facilitates the UE 204A-N to perform analogue beamforming more efficiently thereby allowing targeted data transfer with high accuracy and reduced latency.

In an embodiment, the BS 202, being configured for sending an SRS trigger message to each of the scheduled UEs 204A-N to trigger the transmitting of the SRS sequences within the SRS OFDM signal duration. Each SRS trigger message comprises a split factor setting a number of the TX beams to be swept within the SRS OFDM signal duration. The split factor being an integer with a range from one to a frequency domain down-sampling factor of the SRS OFDM signal.

In an embodiment, the BS 202, being configured for determining the split factor based on a beam switching capability of a UE 204A-N, and a run-time observation of a service type of the UE 204A-N and wireless channel conditions, including a path-loss between the BS 202 and the UE 204A-N.

In an embodiment, the BS 202, being configured for determining the path-loss between the BS 202 and the UE 204A-N based on a power difference between a BS 202 transmission power and a UE 204A-N received power of a downlink reference signal. In an embodiment, the UE 204A-N received power is provided to the BS 202 in a historical measurement report message from the UE 204A-N.

In an embodiment, the BS 202, being configured for determining the path-loss between the BS 202 and the UE 204A-N based on a power difference between a UE 204A-N transmission power and a BS 202 received power of a historical Physical Uplink Shared Channel, PUSCH, signal. In an embodiment, the UE 204A-N transmission power of the PUSCH signal is determined by the BS 202 based on a power-head room, PHR, report embedded within a PUSCH traffic data.

In an embodiment, the BS 202, being configured for determining the path-loss between the BS 202 and the UE 204A-N based on a relative position information between the BS 202 and the UE 204A-N obtained by historical round-trip-time, RTT, measurements.

In an embodiment, the BS 202, being configured for refining the split factor based on wireless channel parameters measured from historically received uplink signals, including one or more of a signal-to-interference-ratio, SINR, a delay spread, and mobility metrics of the UE 204A-N.

In an embodiment, the BS 202, being configured for determining the beam switching capability of the UE 204A-N by determining a latency of the UE TX beam switching. In an embodiment, the latency including a beam switching transition period between a first beam pattern and a second beam pattern in the UE 204A-N within one SRS OFDM signal duration.

In an embodiment, in case one UE 204A-N is scheduled to transmit the SRS sequence within the SRS OFDM signal duration, the BS 202, being configured for independently measuring an SRS sequence receive power for each group of waveform repetitions received within the SRS OFDM signal duration, and identifying a preferred TX beam for the scheduled UE 204A-N by comparing the SRS sequence receive powers measured for different groups of waveform repetitions within the SRS OFDM signal duration.

In an embodiment, in case multiple UEs 204A-N are scheduled to transmit the SRS sequences within the SRS OFDM signal duration, the BS 202, being configured for measuring an SRS sequence receives power corresponding to each of the scheduled UEs 204A-N for each group of waveform repetitions received within the SRS OFDM signal duration with separating the SRS sequences from different UEs 204A-N in the same group of waveform repetitions based on Code Division Multiplexing, CDM, orthogonality of the SRS sequences, and identifying a preferred TX beam for each of the scheduled UEs 204A-N by comparing the measured SRS sequence receive powers corresponding to said UE 204A-N for different groups of waveform repetitions within the SRS OFDM signal duration.

In an embodiment, the BS 202, being further configured for sending an indication message to each of the scheduled UEs 204A-N comprising a first index identifying an SRS OFDM signal and a second index identifying a group of waveform repetitions within the SRS OFDM signal duration on which the preferred TX beam for said UE 204A-N has been measured.

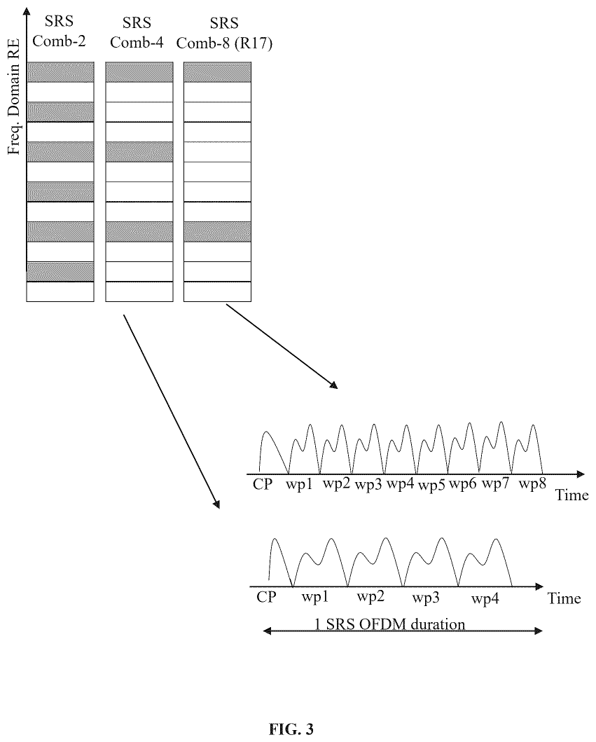

FIG. 3 is an exemplary graphical representation of different SRS comb modes and their waveform repetitions for one SRS OFDM signal in accordance with an implementation of the disclosure. The waveform of the SRS OFDM signal, as defined by 3GPP, has a unique comb structure that is originally designed to allow multiple UEs to transmit SRS sequences simultaneously within a single SRS OFDM signal duration in a frequency-domain multiplexing, FDM manner. According to the present disclosure, the comb-structure of the SRS waveform is utilized to sweep more than one UE TX beams within one SRS OFDM signal duration, where each UE TX beam is applied to a group of time consecutive WPs within one SRS OFDM signal duration. As a result, the required SRS OFDM signals to finish the UE TX beam sweeping can be significantly reduced, thereby reducing the SRS based UE TX beam sweeping latency. The granularity of splitting the SRS OFDM signal to allow sweeping multiple UE TX beams is based on the comb-structure of the SRS waveform pattern, where each repeated waveform within one SRS OFDM signal is transmitted by a distracted UE TX beam. For instance, for a comb-2 SRS OFDM, the UE can sweep up to 2 UE TX beams within one SRS OFDM signal. In another instance, for a comb-4 SRS OFDM, the UE can sweep up to 4 UE TX beams within one SRS OFDM signal. In yet another instance, for a comb-8 SRS OFDM, the UE can sweep up to 8 UE TX beams within one SRS OFDM signal.

The total transmission power per SRS OFDM signal is limited by the maximum allowed transmission power of the UE that transmits the SRS OFDM signal. As more than one UE TX beams is transmitted within one SRS OFDM signal, the power allocated to each UE TX beam is reduced, which affects beam measurement accuracy. To ensure the beam measurement accuracy a BS is adapted to dynamically select a split factor within an SRS OFDM signal based on the propagation conditions of the wireless channel, which optimizes the tradeoff between UE transmission power per UE TX beam and the number of UE TX beams that can be swept within one SRS OFDM signal duration. The split factor is an integer that ranges from one to the frequency domain down-sampling factor of the SRS OFDM signal.

The actual number of UE TX beams that are swept within the one SRS OFDM signal duration is determined by the split factor, which is dynamically communicated to the UE by the BS. The BS dynamically determines the split factor in real-time to optimize the number of the UE TX beams that can be transmitted within the one SRS OFDM signal duration. Each UE TX beam is applied to a group of time constructive waveform repetitions within the SRS OFDM duration, and each WPG is transmitted using a district UE TX beam.

In an embodiment, the BS can select the split factor dynamically to optimize the tradeoff between the beam measurement accuracy and the beam training latency based on specific communication scenarios, which ensures the most efficient use of resources and maintains any potential delays.

In an embodiment, the split factor can be selected based on run-time measurements of the path-loss, PL between the UE and the BS. In wireless channel conditions with small path-loss such as indoor environments with Line of Sight, LOS propagations, the minimal required transmission power per UE TX beam is low. In these scenarios, the BS may select a high split factor within the SRS OFDM signal to speed up the UE TX beam sweeping, which reduces the SRS overhead and reserve more UL spectrum for transmitting a high-priority data packet.

In an embodiment, in wireless channel conditions with high path-loss such as urban environments with Non-Line of Sight, NLOS, propagations, the minimal required transmission power per UE TX beam is high. In these scenarios, the BS may select a low split factor within the SRS OFDM signal to maintain the transmission power per UE TX beam to ensure the accuracy of beam measurement.

In an embodiment, the path-loss, PL information can be determined by the BS (i) based on power difference between the BS transmission power and UE received power of a Downlink, DL reference signal such as a Channel State Information Reference Signal, CSI-RS, or a Synchronization Signal Block, SSB, where the UE received power may be read by the BS from historical L1-Reference Signal Received Power, RSRP, measurement report messages sent by the UE, (ii) based on power difference between the UE transmission power and the BS received power of a historical Physical Uplink Shared Channel, PUSCH, signal, where the UE transmission power of the PUSCH may be read by the BS through the power-head room, PHR report embedded within the PUSCH traffic data, and (iii) based on relative position information between the BS and the UE, such as the propagation delay, where the propagation delay may be derived through historical round-trip-time, RTT, measurements.

In an embodiment, the split factor can be jointly determined based on other channel parameters measured from historically received UL signals, such as, not limiting to, signal-to-interference-ratio, SINR, delay spread, and/or UE mobility metrics such as velocity/Doppler shift/Doppler spread and like. For example, in low SNR channels or channels with higher delay spread, a very high split factor may be avoided to keep sufficient margin for the measurement accuracy of the SRS RSRP. In high mobility scenarios, a high split factor may be prioritized to speed up the UE TX beam sweeping to identify the best UE TX beam as quickly as possible.

Table below shows some examples of split factors for some typical 5G mmWave band communication scenarios.

| | | |
|---|---|---|
| fc(GHz) | 28 | SRS L1-RSRP Link Budget Analysis for typical |
| SCS (kHz) | 120 | 5G propagation scenarios |
| SRS ref. SC | 64 | |
| Num. | | |
| SRS Comb. | 8 | |

| | Free | Urban | Urban | Indoor | Indoor |
|---|---|---|---|---|---|
| | Space | Macro | Micro | Hopspot | Hopspot |
| 5G Propagation Models | Path Loss | 3D-Uma | 3D-Umi | 3D-inH | 3D-inH |
| (Scenarios) | (FSPL) | LOS | NLOS | LOS | NLOS |
| gNB-UE distance (m) | 5000 | 3000 | 250 | 50 | 50 |
| PassLoss (dB) | 135 | 138 | 138 | 91 | 120 |
| UE TX Antenna Gain (Gt/dB) | 6 | 6 | 6 | 6 | 6 |
| gNB TX Antenna Gain (Gr/dB) | 12 | 12 | 9 | 9 | 9 |
| Noise Figure (dB) | 6 | 6 | 6 | 6 | 6 |
| Thermal Noise Power (dBm) | −105 | −105 | −105 | −105 | −105 |
| Target SNR Operation Point | −3 | −3 | −3 | −3 | −3 |
| for SRS LI-RSRP | | | | | |
| measurement | | | | | |
| Minimal Required | 15 | 18 | 21 | −26 | 3 |
| Transmission Power per UE | | | | | |
| TX Beam (dBm) | | | | | |
| Transmission Power for a | 23 | 23 | 23 | 10 | 10 |
| full SRS OFDM (dBm) | | | | | |
| Recommended Split Factor | 4 | 2 | 1 | 8 | 4 |
| per SRS OFDM | | | | | |

The process of optimizing the UE transmission beam pattern involves the BS determining the appropriate split factor and SRS comb value for initiating TX beam sweeping. Subsequently, the BS measures the reception quality including the RSRP, of the received SRS signals which are transmitted by different UE TX beams to identify and indicate the best UE TX beam setting to the UE. At the BS receiver side, the BS measures the received powers i.e. RSRPs corresponding to the different TX beams for each of the UEs. The BS applies the RSRP measurement based on how the BS schedules the simultaneous UEs within a same SRS OFDM signal duration.

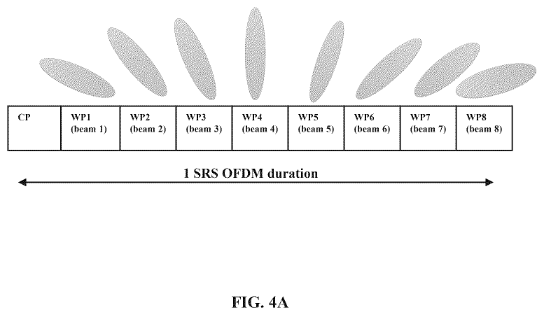

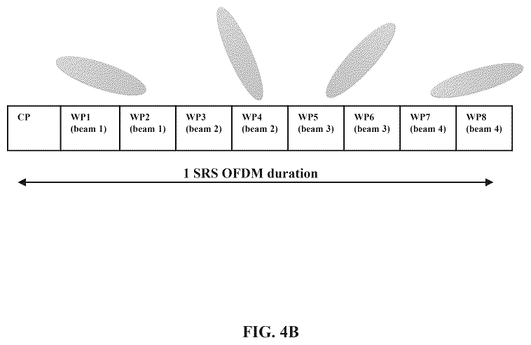

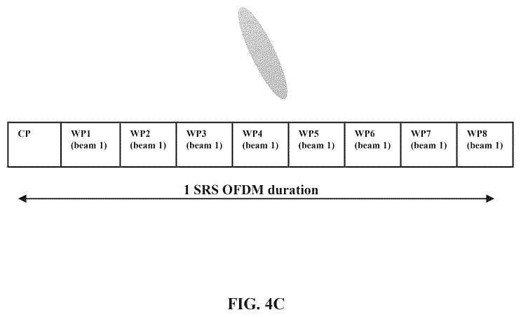

FIGS. 4A-4C are illustrations of a BS with three modes for performing UE Transit, TX beam sweeping by the UE in accordance with implementations of the disclosure. The BS based on different scenarios dynamically selects the split factor value based on three modes, which provides a trade-off between the transmission power per UE TX beam, and the number of UE TX beams within one SRS OFDM signal duration.

FIG. 4A shows the one SRS OFDM signal duration in an ultra-fast mode, where the BS selects split-factor setting or value which is equal to the SRS comb value i.e. 8 as shown in FIG. 4A, indicating to the UE to sweep all 8 UE TX beams per SRS OFDM signal duration.

FIG. 4B shows the one SRS OFDM signal duration in a fast mode, where the BS selects split-factor setting or value as 4, and the SRS comb value as 8, indicating to the UE to sweep 4 UE TX beams per SRS OFDM signal duration.

FIG. 4C shows the one SRS OFDM signal duration in a legacy mode, where the BS selects split-factor setting or value which is minimum, i.e., 1, and the SRS comb value is 8, indicating to the UE to sweep 1 UE TX beam per SRS OFDM signal duration.

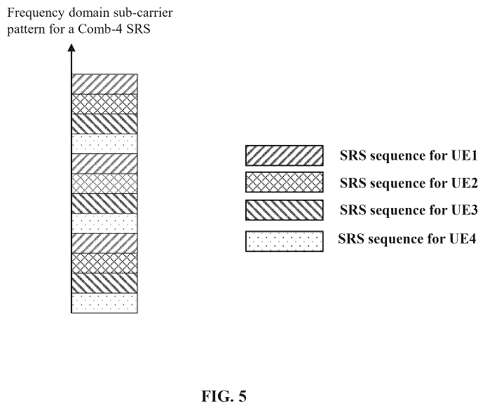

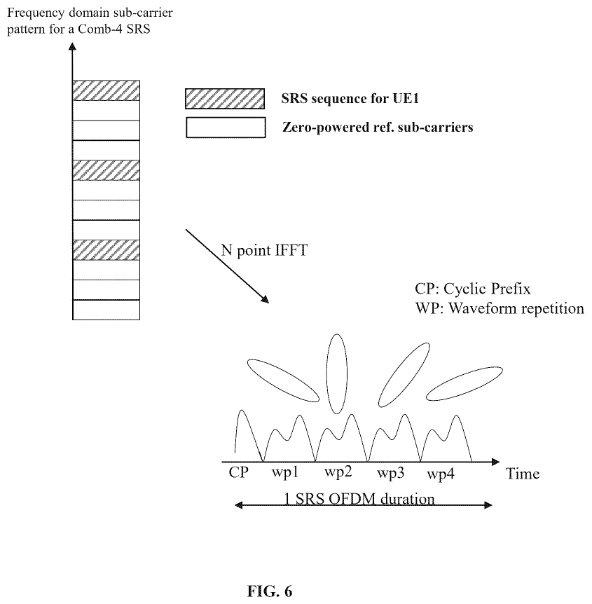

FIG. 5 shows an exemplary graphical representation of frequency domain sub-carrier pattern of comb-4 SRS structure in accordance with an implementation of the disclosure. The frequency domain sub-carrier pattern of comb-4 SRS structure includes 4 UEs transmitting 4 SRS sequences within one SRS OFDM signal duration, where the SRS sequences from different UEs are indicated by different patterns. FIG. 6 shows an exemplary graphical representation of transmitted SRS waveform in a UE transmitter side within the frequency domain sub-carrier pattern of comb-4 SRS structure in accordance with an implementation of the disclosure. For a particular UE, the transmitted SRS sequence down-sample the full SRS bandwidth in the frequency domain, which results in the SRS waveform transmitted from the particular UE having a repeated pattern within one SRS OFDM signal duration in the time domain such that each repeated pattern can be associated with a distracted TX beam. For example, as shown in the FIG. 6, the frequency domain sub-carrier pattern of comb-4 SRS structure have 4 waveform repetitions, i.e. WP1-WP4, within one SRS OFDM signal duration in the time domain. Each WP is transmitted by a districted UE TX beam, allowing faster UE TX beam sweeping.

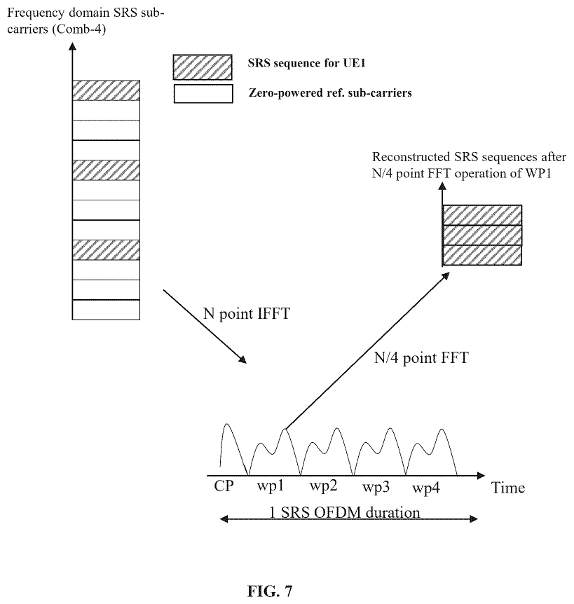

FIG. 7 is a graphical illustration of received SRS waveform in a BS receiver side with single UE in accordance with an implementation of the disclosure. The graphical illustration shows the SRS waveform in the BS receiver side when only a single UE is scheduled within an SRS OFDM signal. In the graphical illustration, the BS selects a single UE to transmit within a same SRS OFDM duration. This approach is only employed when there are few UEs served by the BS, allow other UEs to transmit SRS in other Uplink, UL, slots. When a high priority UE with heavy UL traffic and low latency requirements is selected by the BS, the BS receives the SRS OFDM signal that includes same waveform repetition property as that of the UE transmitter side i.e. having waveform repetition groups. If the UE is transmitting different TX beams on different SRS WPs or WPGs, the BS can independently measure the received power per received WP or WPG, within the SRS OFDM signal duration, to identify the best UE TX beam. If Fast Fourier Transform, FFT size for the full SRS symbol signal is N, and there are 4 waveform repetitions, WP within the SRS OFDM signal, each corresponding to a district UE TX beam, the BS RX baseband processor may apply FFT operations on each of the WP, with a reduced FFT size to be N/4. The waveform after each of N/4 FFT operations corresponds to the original SRS sequence associated with each of the UE TX beams. The BS baseband processor may apply measurement algorithms to estimate the RSRP for each of the UE TX beams.

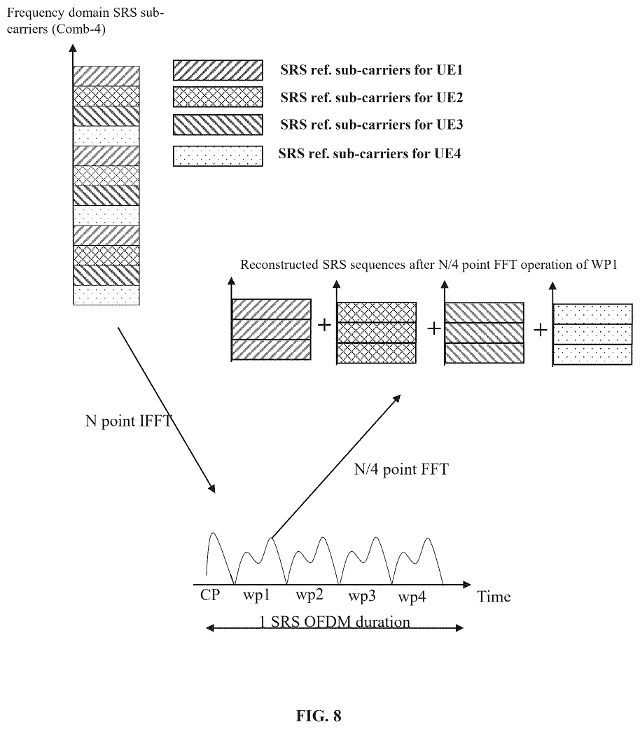

FIG. 8 is an exemplary graphical illustration of received SRS waveform in the BS receiver side with multiple UEs in accordance with an implementation of the disclosure. The graphical illustration shows the received SRS signal when the multiple UEs are scheduled within an SRS OFDM signal. In the graphical illustration, the BS schedules multiple UEs to transmit within a same SRS OFDM signal duration. Each BS received WP, it is a linear combination of the transmitted WPs from all simultaneously transmitting UEs. For instance, there are 4 UEs transmitting 4 SRS sequences within the full SRS bandwidth in a Frequency Division Multiplexing, FDM manner with a FFT size of N. The BS applies N/4 point FFT to transform a received WP into the frequency domain. The derived waveform after the N/4 FFT corresponds to the linear combination of the 4 SRS sequences colliding with each other. The FDM orthogonality between different SRS sequences is broken due to the reduced FFT size, resulting in colliding SRS sequences. However, Code Division Multiplexing, CDM, orthogonality can still be explored as the SRS sequences from different UEs are pseudo-orthogonal such as using M sequence or Zadoff-Chu sequence. In an embodiment, The BS can separate the Reference Signal Received Power, RSRP, estimation from different UE TX beams even from the colliding SRS sequences, with higher computation complexity. The separation may be based on algorithms such as successive interference cancellation, SIC.

Once the BS measured the reception qualities of the swept UE TX beams, the BS selects the best UE TX beam and indicates this information to the UE for updating the TX beam setting for future UL data communications. In an embodiment, the BS sends a message with 2 indexes to indicate the best TX beam to the UE, where first index points to the SRS OFDM signal which is used for UE TX beam sweeping, and second index points to a waveform repetition group, WPG, within the SRS OFDM, where the SRS OFDM is pointed by the first index.

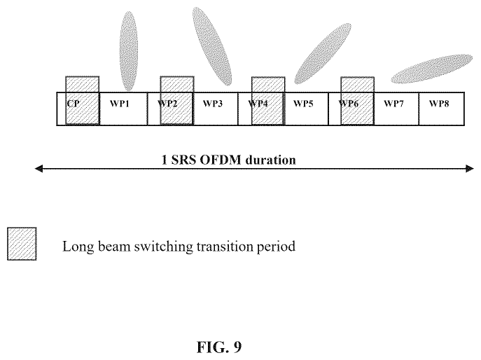

FIG. 9 is a graphical illustration of TX beam sweeping pattern for a UE with long beam switching transition period in accordance with an implementation of the disclosure. In an embodiment, the graphical illustration of the TX beam sweeping pattern is for one SRS orthogonal frequency-division multiplexing, OFDM duration, with a split factor of 4. In an embodiment, the split factor may be jointly determined based on UE TX beam switching latency capability of the UE. The phase shifter setting may be applied in the analogue domain, which results in a short transition period of a Radio Frequency, RF analogue phase shifter between configuration of a phase setting and actual application of phase shifting in the RF circuitry. During the transition period, the radiated TX signal is not in the desired beam direction, leading to a loss of Reference Signal Received Power, RSRP, measurement accuracy in the BS RX side. The ratio between the beam switching time and the duration of one WP determines measurement accuracy loss. The beam switching transition period is more than half of the WP duration, as shown in FIG. 9. If the UE TX beam is still swept per WP, which leads to more than 3 dB accuracy loss for RSRP measurement by the BS. In the graphical illustration, the split factor is reduced to 4 and the BS receiver may skip the WPs with even indexes while may still correctly measuring all 4 UE TX beams without accuracy loss.

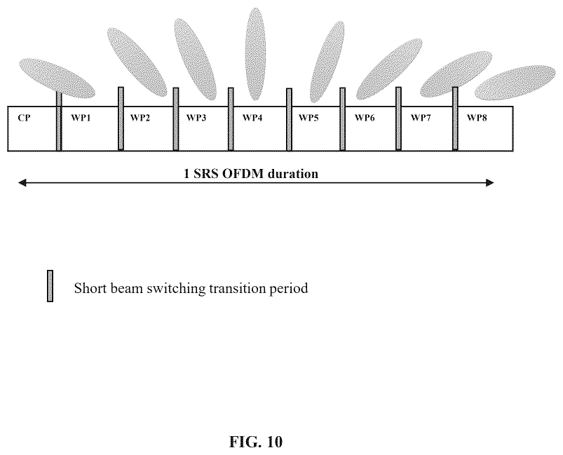

FIG. 10 is a graphical illustration of TX beam sweeping pattern for a UE with short beam switching transition period in accordance with an implementation of the disclosure. In the graphical representation, the transition period during beam switching is less than 10% of a WP duration, which leads to negligible RSRP measurement accuracy loss of less than 0.5 dB for the BS. The BS may choose a split factor of 8 to speed up the UE TX beam sweeping process. The split factor is an integer that ranges from one to a frequency domain down-sampling factor of the SRS orthogonal frequency-division multiplexing, OFDM signal. The maximal number of UE TX beams that can be swept in the one SRS OFDM signal is equal to the SRS comb number i.e. same as the split factor, while the minimal number of UE TX beams that can be swept within one SRS OFDM signal is equal to 1 i.e. with a split factor of 1, which reverts to the legacy mode.

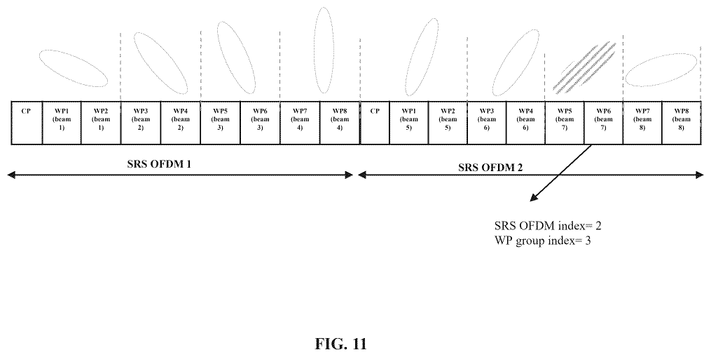

FIG. 11 is an exemplary graphical illustration of Base Station, BS, sent message to a User Equipment, UE, indicating a best TX beam in accordance with an implementation of the disclosure. The BS transmits 2 Sound Reference Signal, SRS, orthogonal frequency-division multiplexing, OFDM, signals for UE TX beam sweeping, with 4 UE TX beams being swept within each SRS OFDM signal, resulting in 4 waveform repetitions, WPGs within the SRS OFDM signal. The UE TX beam with the best Reference Signal Received Power, RSRP, measurement in the BS side is marked by a dash pattern. To indicate the UE TX beam to the UE, the BS sends a beam indication message with two indexes. The first index points to the 2nd SRS OFDM signal and the second index points to the 3rd WP group (consisting of the WP5 and WP6) within the 2nd SRS OFDM signal. In an embodiment, the 2 indexes are included in Downlink, DL, Medium Access Control, MAC, Control Element, CE messages or DL Downlink Control Information, DCI messages, which are sent from the BS to the UE.

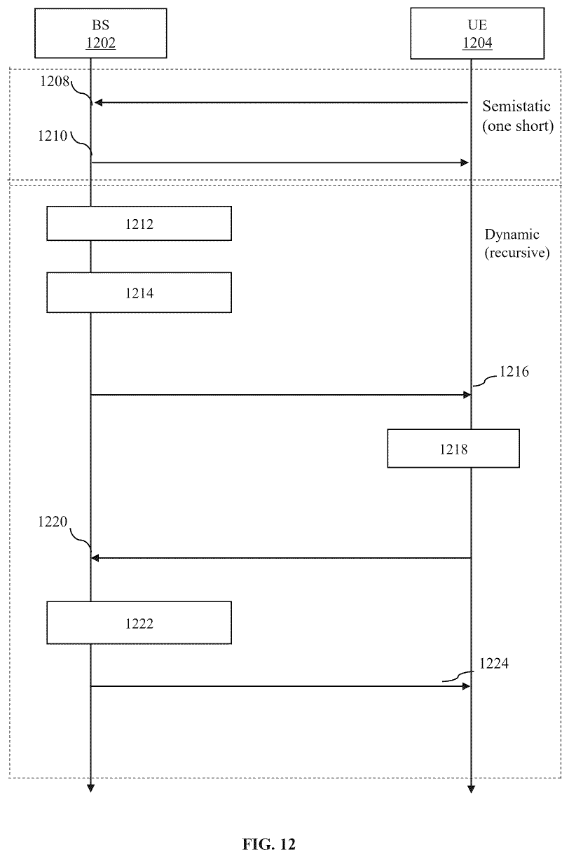

FIG. 12 is an interaction diagram illustrating a procedure of adaptive SRS TX beam sweeping in accordance with an implementation of the disclosure. The interaction diagram includes a UE 1204 and a BS 1202. The method is divided two-parts, semi-static and a dynamic procedure. The semi-static procedure is a one short configuration when the UE 1204 is connected to the BS 1202. At a step 1208, the UE 1204 indicates the UE TX beam sweeping latency information to the BS 1202. The information is provided by the UE 1204 as an additional field input within the UE capability indication message sent to the BS 1202. On receiving the UE TX beam sweeping latency information from the UE 1204, at a step 1210, the BS 1202 determines the SRS comb value and sends a Radio Resource Control, RRC message to the UE 1204 to configure the SRS waveform pattern accordingly which can be used for UE TX beam sweeping. The SRS waveform pattern consists of at least a SRS comb value. For the purpose of this disclosure, a SRS comb value implies the maximal possible number of UE TX beams that can be swept within a SRS OFDM duration.

The dynamic procedures are applied thereafter recursively when the UE 1204 is connected to the BS 1202, so as to keep the best UE TX beam on track especially when the UE 1204 is moving. In the dynamic procedure, at a step 1212, the BS 1202 initially determines the path-loss (PL) information between the UE 1204 and the BS 1202. Based on the PL information, at a step 1214, the BS 1202 then determines the minimal required transmission power per UE TX beam and then accordingly determines the split factor for the UE 1204 to apply the UE TX beam sweeping within a SRS OFDM signal duration. At a step 1216, the BS 1202 sends a trigger information to the UE 1204 to activate the UE TX beam sweeping according to the split factor. The trigger information may be carried as part of the DL DCI message or DL MAC CE message. The trigger information is associated to at least one split factor value for at least one SRS OFDM signal. The split factor is an integer number which is larger than 0 and is divisible by the SRS comb value. On receiving the trigger information from the BS 1202, at a step 1218, the UE 1204 determines the WPG pattern as well as the TX beam sweeping pattern within the SRS OFDM signals, based on the split factor as well as the SRS comb value. At a step 1220, the UE 1204 transmits the SRS OFDM signals to the BS 1202 based on the determined TX beam patterns, wherein each WPG is transmitted by a district UE TX beam. Thereafter, in the BS 1202 side, at a step 1222, the BS 1202 measures the RSRPs of the received WPGs which are associated to district UE TX beams. At a step 1224, the BS 1202 sends an indication message to the UE 1204 which corresponds to at least two indexes, wherein a first index points to a SRS OFDM signal within which the best UE TX beam has been measured, while a second index points to a WPG on which the best UE TX beam has been measured. With this information, the UE 1204 knows its best UE TX beam setting and can update the TX beam settings for UL data transmission.

As the TX beam switching pattern is determined by the waveform repetition pattern inside of the SRS OFDM signal, the method significantly reduces the TX beam sweeping latency. Dynamic selection of the split factor within the SRS OFDM signal, to optimize the tradeoff between the allocated transmission power per TX beam and the number of swept TX beams within the SRS OFDM signal facilitates optimizing the beam measurement accuracy for different communication scenarios. Further, the indication message is sent in form of 2 indexes thereby reducing message overhead.

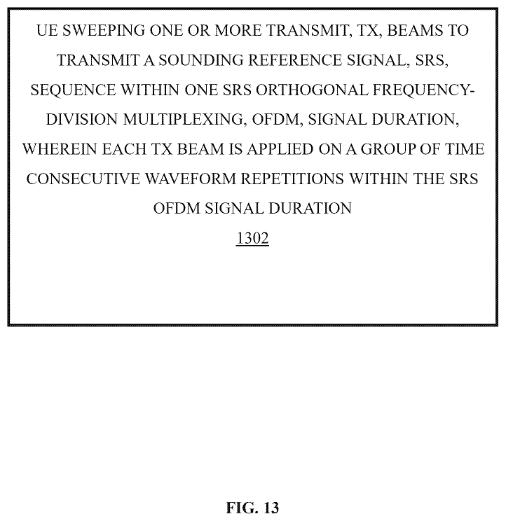

FIG. 13 illustrates a flow diagram of a method of adaptive transmission beam sweeping in accordance with an implementation of the disclosure. At a step 1302, the method includes a user equipment, UE, sweeping one or more transmit, TX, beams to transmit a Sounding Reference Signal, SRS, sequence within one SRS orthogonal frequency-division multiplexing, OFDM, signal duration. Each TX beam is applied on a group of time consecutive waveform repetitions within the SRS OFDM signal duration.

This method facilitates a substantial reduction in the latency during SRS based UE TX beam sweeping while maintaining accurate UE TX beam measurement and detection on the BS side. This method being dynamic in nature, facilitates optimization of beam measurement accuracy for various communication scenarios. This method requires low training overhead for mmWave band communications, and efficiently identifies the best UE TX beam with reduced SRS based UE TX beam sweeping latency, even in scenarios where the UE is heavily loaded with UL data traffic.

In an embodiment, the method further includes receiving an SRS trigger message from a BS by the UE. The SRS trigger message triggers the transmitting of the SRS sequence within the SRS OFDM signal duration and includes a split factor setting a number of the TX beams to be swept within the SRS OFDM signal duration. The split factor is an integer with a range from one to a frequency domain down-sampling factor of the SRS OFDM signal. The method further includes determining a TX beam switching pattern by the UE for transmitting the SRS sequence within the SRS OFDM signal duration based on the split factor and the frequency domain down-sampling factor of the SRS OFDM signal. The method further includes determining a transmission power allocated to each TX beam to be swept within the SRS OFDM signal duration in accordance with the split factor by the UE.

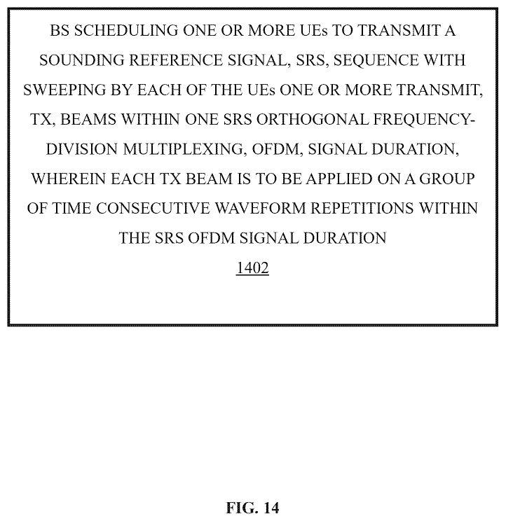

FIG. 14 illustrates a flow diagram of a method of controlling adaptive transmission beam sweeping in accordance with an implementation of the disclosure. At a step 1402, the method includes a base station, BS, scheduling one or more UEs to transmit a Sounding Reference Signal, SRS, sequence with sweeping by each of the UEs one or more transmit, TX, beams within one SRS orthogonal frequency-division multiplexing, OFDM, signal duration. Each TX beam is to be applied on a group of time consecutive waveform repetitions within the SRS OFDM signal duration.

This method enables the BS to efficiently identify the best UE TX beam with reduced latency following the SRS based UE TX beam sweeping. This method enables the TX signal to steer toward the best direction of the base station receiver, facilitating efficient analogue beamforming. This method is dynamic and is recursively activated to perform accurate beam measurements by the BS even when the UE is moving.

In an embodiment, the method further including the BS sending an SRS trigger message to each of the scheduled UEs to trigger the transmitting of the SRS sequences within the SRS OFDM signal duration. Each SRS trigger message comprises a split factor setting a number of the TX beams to be swept within the SRS OFDM signal duration. The split factor being an integer with a range from one to a frequency domain down-sampling factor of the SRS OFDM signal.

In an embodiment, the method further includes the BS defining the split factor based on a beam switching capability of a UE, and a run-time observation of a service type of the UE and wireless channel conditions, including a path-loss between the BS and the UE.

In an embodiment, the path-loss between the BS and the UE is determined by the BS based on a power difference between a BS transmission power and a UE received power of a downlink reference signal. The UE received power is provided to the BS in a historical measurement report message from the UE.

In an embodiment, the path-loss between the BS and the UE is determined by the BS based on a power difference between a UE transmission power and a BS received power of a historical Physical Uplink Shared Channel, PUSCH, signal. The UE transmission power of the PUSCH signal is determined by the BS based on a power-head room, PHR, report embedded within a PUSCH traffic data.

In an embodiment, the path-loss between the BS and the UE is determined by the BS based on a relative position information between the BS and the UE obtained by historical round-trip-time, RTT, measurements.

In an embodiment, the method further including the BS refining the split factor based on wireless channel parameters measured from historically received uplink signals, including one or more of a signal-to-interference-ratio, SINR, a delay spread, and mobility metrics of the UE.

In an embodiment, the beam switching capability of the UE includes a latency of the UE TX beam switching. The latency including a beam switching transition period between a first beam pattern and a second beam pattern in the UE within one SRS OFDM signal duration.

In an embodiment, if the BS schedules one UE to transmit the SRS sequence within the SRS OFDM signal duration, the method including the BS independently measuring an SRS sequence receive power for each group of waveform repetitions received within the SRS OFDM signal duration, and the BS identifying a preferred TX beam for the scheduled UE by comparing the SRS sequence receive powers measured for different groups of waveform repetitions within the SRS OFDM signal duration.

In an embodiment, if the BS schedules multiple UEs to transmit the SRS sequences within the SRS OFDM signal duration, the method further including the BS measuring an SRS sequence receive power corresponding to each of the scheduled UEs for each group of waveform repetitions received within the SRS OFDM signal duration with separating the SRS sequences from different UEs in the same group of waveform repetitions based on Code Division Multiplexing, CDM, orthogonality of the SRS sequences, and the BS identifying a preferred TX beam for each of the scheduled UEs by comparing the measured SRS sequence receive powers corresponding to said UE for different groups of waveform repetitions within the SRS OFDM signal duration.

In an embodiment, the method further including the BS sending an indication message to each of the scheduled UEs comprising a first index identifying an SRS OFDM signal and a second index identifying a group of waveform repetitions within the SRS OFDM signal duration on which the preferred TX beam for said UE has been measured.

In an implementation, a non-transitory computer readable medium having instructions stored thereon which, when executed by a processor, cause the processor to implement a method of adaptive transmission beam sweeping.

In an implementation, a non-transitory computer readable medium having instructions stored thereon which, when executed by a processor, cause the processor to implement a method of controlling adaptive transmission beam sweeping.

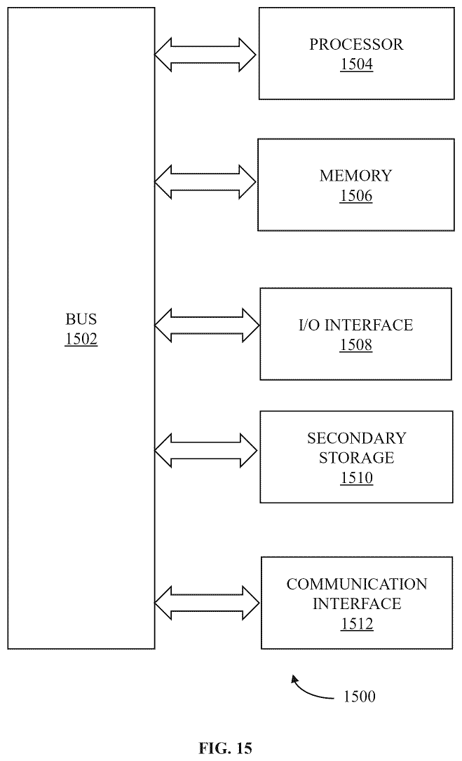

FIG. 15 is an illustration of a computer system (e.g., a user equipment) in which the various architectures and functionalities of the various previous implementations may be implemented.

As shown, the computer system 1500 includes at least one processor 1504 that is connected to a bus 1502, wherein the computer system 1500 may be implemented using any suitable protocol, such as PCI (Peripheral Component Interconnect), PCI-Express, AGP (Accelerated Graphics Port), Hyper Transport, or any other bus or point-to-point communication protocol(s). The computer system 1500 also includes a memory 1506.

Control logic (software) and data are stored in the memory 1506 which may take a form of random-access memory, RAM. In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit, CPU, and bus implementation. Of course, the various modules may also be situated separately or in various combinations of semiconductor platforms per the desires of the user.

The computer system 1500 may also include a secondary storage 1510. The secondary storage 1510 includes, for example, a hard disk drive and a removable storage drive, representing a floppy disk drive, a magnetic tape drive, a compact disk drive, digital versatile disk, DVD, drive, recording device, universal serial bus, USB, flash memory. The removable storage drive at least one of reads from and writes to a removable storage unit in a well-known manner.

Computer programs, or computer control logic algorithms, may be stored in at least one of the memory 1506 and the secondary storage 1510. Such computer programs, when executed, enable the computer system 1500 to perform various functions as described in the foregoing. The memory 1506, the secondary storage 1510, and any other storage are possible examples of computer-readable media.

In an implementation, the architectures and functionalities depicted in the various previous figures may be implemented in the context of the processor 1504, a graphics processor coupled to a communication interface 1512, an integrated circuit (not shown) that is capable of at least a portion of the capabilities of both the processor 1504 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated for entertainment purposes, an application-specific system. For example, the computer system 1500 may take the form of a desktop computer, a laptop computer, a server, a workstation, a game console, an embedded system.

Furthermore, the computer system 1500 may take the form of various other devices including, but not limited to a personal digital assistant, PDA, device, a mobile phone device, a smart phone, a television, and so forth. Additionally, although not shown, the computer system 1500 may be coupled to a network (for example, a telecommunications network, a local area network, LAN, a wireless network, a wide area network, WAN, such as the Internet, a peer-to-peer network, a cable network, or the like) for communication purposes through an I/O interface 1508.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

What is claimed is:

1. A method of adaptive transmission beam sweeping, the method comprising:
a UE (102, 204A-N, 1204), sweeping one or more transmit, TX, beams (104A-N) to transmit a Sounding Reference Signal, SRS, sequence within one SRS orthogonal frequency-division multiplexing, OFDM, signal duration, wherein each TX beam is applied on a group of time consecutive waveform repetitions within the SRS OFDM signal duration.

2. The method of claim 1, further comprising:
receiving by the UE (102, 204A-N, 1204) an SRS trigger message from a BS (202, 1202), wherein the SRS trigger message triggers the transmitting of the SRS sequence within the SRS OFDM signal duration and comprises a split factor setting a number of the TX beams to be swept within the SRS OFDM signal duration, the split factor being an integer with a range from one to a frequency domain down-sampling factor of the SRS OFDM signal,
determining by the UE (102, 204A-N, 1204) a TX beam switching pattern for transmitting the SRS sequence within the SRS OFDM signal duration based on the split factor and the frequency domain down-sampling factor of the SRS OFDM signal, and
determining by the UE (102, 204A-N, 1204) a transmission power allocated to each TX beam to be swept within the SRS OFDM signal duration in accordance with the split factor.

3. A method of controlling adaptive transmission beam sweeping, the method comprising:
a BS (202, 1202), scheduling one or more UEs (102, 204A-N, 1204) to transmit a Sounding Reference Signal, SRS, sequence with sweeping by each of the UEs (102, 204A-N, 1204) one or more transmit, TX, beams (104A-N) within one SRS orthogonal frequency-division multiplexing, OFDM, signal duration, wherein each TX beam is to be applied on a group of time consecutive waveform repetitions within the SRS OFDM signal duration.

4. The method of claim 3, further comprising the BS (202, 1202) sending an SRS trigger message to each of the scheduled UEs (102, 204A-N, 1204) to trigger the transmitting of the SRS sequences within the SRS OFDM signal duration, wherein each SRS trigger message comprises a split factor setting a number of the TX beams to be swept within the SRS OFDM signal duration, the split factor being an integer with a range from one to a frequency domain down-sampling factor of the SRS OFDM signal.

5. The method of claim 4, further comprising the BS (202, 1202) defining the split factor based on a beam switching capability of a UE (102, 204A-N, 1204), and a run-time observation of a service type of the UE (102, 204A-N, 1204) and wireless channel conditions, including a path-loss between the BS (202, 1202) and the UE (102, 204A-N, 1204).

6. The method of claim 5, wherein the path-loss between the BS (202, 1202) and the UE (102, 204A-N, 1204) is determined by the BS (202, 1202) based on a power difference between a BS transmission power and a UE received power of a downlink reference signal, wherein the UE (102, 204A-N, 1204) received power is provided to the BS (202, 1202) in a historical measurement report message from the UE (102, 204A-N, 1204).

7. The method of claim 5, wherein the path-loss between the BS (202, 1202) and the UE (102, 204A-N, 1204) is determined by the BS (202, 1202) based on a power difference between a UE transmission power and a BS received power of a historical Physical Uplink Shared Channel, PUSCH, signal, wherein the UE (102, 204A-N, 1204) transmission power of the PUSCH signal is determined by the BS (202, 1202) based on a power-head room, PHR, report embedded within a PUSCH traffic data.

8. The method of claim 5, wherein the path-loss between the BS (202, 1202) and the UE (102, 204A-N, 1204) is determined by the BS (202, 1202) based on a relative position information between the BS (202, 1202) and the UE (102, 204A-N, 1204) obtained by historical round-trip-time, RTT, measurements.

9. The method of claim 5, further comprising the BS (202, 1202) refining the split factor based on wireless channel parameters measured from historically received uplink signals, including one or more of a signal-to-interference-ratio, SINR, a delay spread, and mobility metrics of the UE (102, 204A-N, 1204).

10. The method of claim 5, wherein the beam switching capability of the UE (102, 204A-N, 1204) includes a latency of the UE TX beam switching, the latency comprising a beam switching transition period between a first beam pattern and a second beam pattern in the UE (102, 204A-N, 1204) within one SRS OFDM signal duration.

11. The method of claim 3, further comprising, if the BS (202, 1202) schedules one UE (102, 204A-N, 1204) to transmit the SRS sequence within the SRS OFDM signal duration:
the BS (202, 1202) independently measuring an SRS sequence receive power for each group of waveform repetitions received within the SRS OFDM signal duration, and
the BS (202, 1202) identifying a preferred TX beam for the scheduled UE (102, 204A-N, 1204) by comparing the SRS sequence receive powers measured for different groups of waveform repetitions within the SRS OFDM signal duration.

12. The method of claim 3, further comprising, if the BS (202, 1202) schedules multiple UEs (102, 204A-N, 1204) to transmit the SRS sequences within the SRS OFDM signal duration:
the BS (202, 1202) measuring an SRS sequence receive power corresponding to each of the scheduled UEs (102, 204A-N, 1204) for each group of waveform repetitions received within the SRS OFDM signal duration with separating the SRS sequences from different UEs (102, 204A-N, 1204) in the same group of waveform repetitions based on Code Division Multiplexing, CDM, orthogonality of the SRS sequences, and
the BS (202, 1202) identifying a preferred TX beam for each of the scheduled UEs (102, 204A-N, 1204) by comparing the measured SRS sequence receive powers corresponding to said UE (102, 204A-N, 1204) for different groups of waveform repetitions within the SRS OFDM signal duration.

13. The method of claim 11, further comprising:
the BS (202, 1202) sending an indication message to each of the scheduled UEs (102, 204A-N, 1204) comprising a first index identifying an SRS OFDM signal and a second index identifying a group of waveform repetitions within the SRS OFDM signal duration on which the preferred TX beam for said UE (102, 204A-N, 1204) has been measured.

14. A BS (202, 1202), being configured for:
scheduling one or more UEs (102, 204A-N, 1204) to transmit a Sounding Reference Signal, SRS, sequence with sweeping by each of the UEs (102, 204A-N, 1204) one or more transmit, TX, beams (104A-N) within one SRS orthogonal frequency-division multiplexing, OFDM, signal duration, wherein each TX beam is to be applied on a group of time consecutive waveform repetitions within the SRS OFDM signal duration.

15. The BS (202, 1202), of claim 14, being configured for sending an SRS trigger message to each of the scheduled UEs (102, 204A-N, 1204) to trigger the transmitting of the SRS sequences within the SRS OFDM signal duration, wherein each SRS trigger message comprises a split factor setting a number of the TX beams to be swept within the SRS OFDM signal duration, the split factor being an integer with a range from one to a frequency domain down-sampling factor of the SRS OFDM signal.

16. The BS (202, 1202), of claim 15, being configured for determining the split factor based on a beam switching capability of a UE (102, 204A-N, 1204), and a run-time observation of a service type of the UE (102, 204A-N, 1204) and wireless channel conditions, including a path-loss between the BS (202, 1202) and the UE (102, 204A-N, 1204).

17. The BS (202, 1202), of claim 16, being configured for determining the path-loss between the BS (202, 1202) and the UE (102, 204A-N, 1204) based on a power difference between a BS transmission power and a UE received power of a downlink reference signal, wherein the UE received power is provided to the BS (202, 1202) in a historical measurement report message from the UE (102, 204A-N, 1204).

18. The BS (202, 1202), of claim 16, being configured for determining the path-loss between the BS (202, 1202) and the UE (102, 204A-N, 1204) based on a power difference between a UE transmission power and a BS received power of a historical Physical Uplink Shared Channel, PUSCH, signal, wherein the UE transmission power of the PUSCH signal is determined by the BS (202, 1202) based on a power-head room, PHR, report embedded within a PUSCH traffic data.

19. The BS (202, 1202), of claim 16, being configured for determining the path-loss between the BS (202, 1202) and the UE (102, 204A-N, 1204) based on a relative position information between the BS (202, 1202) and the UE (102, 204A-N, 1204) obtained by historical round-trip-time, RTT, measurements.

20. The BS (202, 1202), of claim 16, being configured for refining the split factor based on wireless channel parameters measured from historically received uplink signals, including one or more of a signal-to-interference-ratio, SINR, a delay spread, and mobility metrics of the UE (102, 204A-N, 1204).
